(19) United States
(12) Patent Application Publication
(10) Pub. No.: US 2026/0008061 A1
(43) Pub. Date: Jan. 8, 2026

(54) ROLLER MILL AND SCRAPER FOR A ROLLER MILL

(71) Applicant: Swisca AG, Appenzell (CH)

(72) Inventors: Adrian Schaffer, Appenzell (CH); Bruno Fässler, Appenzell (CH)

(21) Appl. No.: 18/992,640

(22) PCT Filed: Jul. 11, 2023
(86) PCT No.: PCT/EP2023/069210

§ 371 Date: Jan. 9, 2025

(30) Foreign Application Priority Data
Jul. 12, 2022 (CH) CH000831/2022

(51) Int. Cl. B02C 4/40; B02C 4/02

(52) U.S. Cl. CPC B02C 4/40; B02C 4/02

(57) ABSTRACT

A roller mill includes a scraper and at least one pair of grinding rollers, between which a grinding material can be reduced in size. The grinding rollers are carried by a chassis, wherein in a manner known per se, apart from a drive mechanism for a rotation movement of the grinding rollers, a mechanism for engaging and disengaging the rollers can also be present. The scraper includes a knife with a scraping edge which can be pressed against a surface of one of the grinding rollers. The scraper also includes a base which is assembled or can be assembled on the chassis, as well as a knife holder, to which the knife is fastened. The knife holder can be biased against the surface of the grinding roller relative to the base by way of a spring force and thus can be biased by this against the grinding roller.

### BACKGROUND OF THE INVENTION

### Field of the Invention

The invention relates to a roller mill as well as to a scraper for a roller mill.

### Description of Related Art

Roller mills are used in cereal mills or other mills for foodstuff processing. A roller mill includes at least one pair of grinding rollers, between which a grinding gap is formed on operation and which rotate for example at different speeds, in order to reduce the size of the grinding material in the grinding gap. Concerning this procedure, the grinding rollers are pressed against one another by way of high pressing forces, which is why a part of the grinding material sticks to the grinding rollers after the passage through the grinding gap. For this reason, the roller mill includes a scraper with which grinding material which sticks to the grinding roller is scraped off. Such a scraper generally includes a blade which is pressed onto the respective grinding roller by way of a pressing pressure along a scraping edge.

One challenge in the context of the scraper is the fact that grinding rollers are often cambered and the blade must be adapted to the shape of the grinding roller. However, the surface of the grinding roller as well as the shape of the blade can be subjected to changes over time on account of wearing.

For this reason, according to the state of the art, flexible blades of spring steel which conformly bear on the surface of the grinding roller have been suggested. Given relatively short rollers as were used earlier, this functioned in a satisfactory manner. Since the flexibility of the blades is generally not sufficient in order to effect an adequate adaption along the complete grinding roller length in the case of longer rollers, further measures have also been suggested. CH 201 605 and GB 477 188 suggest the incorporation of a blade into slotted tube elements, in which they are movably mounted in a loose manner, so that they execute certain tilting movements and by way of this can conformly bear on the grinding roller. The necessary pressing force upon the tube elements is exerted by a linkage which is coupled to the disengagement mechanism of the grinding rollers, or alternatively via a spring mechanism which engages between arms of the tube elements. The space requirement however is relatively large, since the knife must be relatively long in the y-direction (direction along the knife plane perpendicularly to the course of the scraping edge). However, this approach furthermore also has its limits given longer rollers on account of the intrinsic stiffness of the knife.

Alternative solutions include the provision of a stiff mounting of several mechanical tensioning elements which are distributed over the length of the scraper, by way of which the blade is bent, adapted to the roller surface and thus pressed onto the roller. This solution has the disadvantage that it demands an extensive adaption step which presupposes a certain technical know-how and that it does not permit a compensation given deformations during operation.

A further possibility according to EP 3 572 153 lies in an elastic, soft mounting of the blade by an elastomer strip which together with the blade can be held in a clamping profile. Concerning this solution, it is disadvantageous that it renders necessary the use of an elastomer whose characteristics change in the course of time. Furthermore, concerning the solution which is suggested in EP 3 572 153, the pressing pressure of the blade must be exerted by a counter-weight, which renders the device heavy and complicates the assembly and the exchange of the blade.

Scrapers with blades are described in GB 1 015 565 and these at the rear side include a recess and at the front side include incisions from the scraping edge, between which the tongues of the scraper form. The incisions form a non-right angle to the scraping edge, on account of which the position of the corner on the scraping edge dislocates given an increased wearing of the blade, by which means a wearing of the roller which is caused by the corners of the tongues and which is greater compared to the wearing due to the remaining blade, over time affects the complete roller length.

### SUMMARY OF THE INVENTION

It is the object of the invention to provide a scraper for a roller mill as well as a roller mill with which such a scraper, which overcome the disadvantages of the state of the art. In particular, it is the object of the invention to provide a compact scraper which in particular permits a good and uniform pressing of the scraping edge onto the grinding roller.

According to the first aspect of the present invention, it is the case of a scraper for a roller mill as well as a roller mill with this scraper. The roller mill includes at least one pair of grinding rollers, between which a grinding material can be reduced in size. The grinding rollers are carried by a chassis (for example with a mount and/or housing), wherein in a manner known per se, apart from a drive mechanism for a rotation movement of the grinding rollers-generally at different rotation speeds-a mechanism for engaging and disengaging the grinding rollers can be present. The scraper includes a knife with a scraping edge which is pressable against the surface of one of the grinding rollers. Furthermore, the scraper includes a base which is assembled or can be assembled on the chassis, as well as a knife holder to which the knife is fastened. The knife holder can be biased against the surface of the grinding roller relative to the base by way of a spring force and thus is pressable against the grinding roller by this spring force.

The knife holder can be a knife clamp, in which the knife is clamped.

The base can be of one or more parts and is assembled to the chassis of the roller mill for example in a fixed manner. In a simple case, the base at each of the two axial ends of the scraper can include a base plate, relative to which the knife holder is pivotably mounted.

In the case of a multi-part design of the base, in embodiments this can include at least one base fixed part—for example with the mentioned base plate—and at least one movable base part. A movable base part can be movable, for example by way of the disengagement movement of the grinding rollers—or by way of an activation mechanism which effects this—in order to lift the scraping edge of the knife from the surface of the respective grinding roller as soon as the grinding rollers are disengaged relative to one another. In this case, the spring force can act between the moving base part—for example a base pivot unit—on the one hand and the knife holder on the other hand. The movement of the moving base part from the disengaged into the engaged position can therefore firstly pivot the knife holder with the knife fastened thereto to such an extent that the scraping edge bears on the grinding roller and then (further) bias the spring, whilst the bearing of the scraping edge on the grinding roller prevents a further pivoting of the knife holder.

Such a movable base part can be provided for example in particular for the knife which interacts with the stationary grinding roller of a roller pair, whereas in any case one can make do without such on the side of the other grinding roller—whose axis is displaced given the disengagement movement—by way of the knife, given the disengagement movement, accompanying the grinding roller only up to a mechanical stop which then effects a lifting of the knife from the grinding roller.

The biasing by the spring force renders a counterweight superfluous. For this reason, it permits a particularly compact construction manner. Due to the fact that the spring force acts between the knife holder and the base, it is furthermore well-defined at all times. This is the case when the spring is fixedly clamped relative to the chassis at the end which is opposite the knife holder as well as when it is clamped in a movable base part. In the latter case, the scraper in particular can be configured such that the position and orientation of the movable base part is defined by the state of the pair of grinding rollers and differs between an engaged state and a disengaged state.

The fact that the spring force acts between the knife holder and the base and for this reason is well-defined at all times is in contrast to approaches according to the state of the art, concerning which a spring force acts between two knives and therefore the position of one knife influences the spring force upon the respective other knife.

The spring force in particular can be effected by way of one or more springs per knife holder. An further advantage of the concept of letting the spring force act between the knife holder and the base lies in the fact that the spring which acts relative to the base can be attached in a housed manner, i.e. in a manner shielded from the grinding material. In particular, the spring can be present in a hollowing in the inside of the knife holder and/or of the base. Such a hollowing can extend for example along the pivot axis of the knife holder. It can also serve for guiding the knife holder, for example by a guide pin of the base which engages into it. The one end of the spring can also be fastened to such a guide pin, whereas the other end is in engagement with an engagement structure of the knife holder. In embodiments with a moving base part, the guide pin can participate in a pivoting movement of this movable base part, in order to (further) bias the spring in the mentioned manner.

A spring which is not arranged in the product space has advantages with regard to the hygiene. Moreover, given a defect—for example a breakage of the spring-no constituents of the spring get into the product flow.

With regard to manufacturing technology, it can be favourable if the knife holder forms a knife clamp as a profile body which is extended along the axial direction, possibly with the hollowing and an engagement structure, into which an end of the spring which is possibly arranged in the opening can engage, in order to exert the spring force.

In particular, the scraper can include a scraping unit with a knife and knife holder for each of the two grinding rollers of a roller pair. Both knives can each be preloaded against the surface relative to the base. Herein, the knife holders of the two knives can share the base, i.e. be fastened to the same base and be preloaded or preloadable relative to this, which as mentioned does not rule out the base being of several parts. By way of this approach, a scraper with two scraping devices can therefore be present as an assembly (module). Such an assembly can be preassembled and merely needs to be fastened to the chassis—i.e. the assembly and disassembly of the scraper is significantly improved in comparison to the state of the art. The compact construction manner also has advantages with regard to the hygiene and access for the purpose of taking samples below the rollers.

In embodiments, the knife includes a plurality of (first) recesses. These are arranged between the knife holder (for example knife clamp) and the scraping edge-which does not rule out them being able to extend into the region which is received by the knife holder. These first recesses have the effect of the knife being adequately flexible even given a sufficiently high strength of the knife material, in order to conformably bear on the surface of the roller in a uniform manner, even without an elastic mounting. A good conformable bearing means that the knife possibly exerts a uniform pressing force locally at different axial positions and therefore locally has the same scraping function and same wearing.

The first recesses in particular are arranged at a distance to the scraping edge, i.e. they do not extend up to the scraping edge. The first recesses (independently of their shape) are generally window-like, i.e. can be surrounded by the material of the knife along their complete peripheral line.

In embodiments, the scraping edge is uninterrupted in particular along its axial extension. This has the advantage that the scraping is effected uniformly along the complete axial extension of the grinding roller without remaining traces. Due to the first recesses then lying between two regions which are uninterrupted along their axial extension, the knife as a whole has a torsional stiffness despite the increased flexibility of the knife due to the recesses.

However, it is also possible for the knife, additionally to the first recesses or alternatively to this, to have different shapes of a targeted weakening which permits a good conforming contact. Such for example can be incisions and/or subdivisions. Such incisions or subdivisions can extend downwards from the scraping edge (in the y-direction, i.e. the direction along the knife plane perpendicular to the course of the scraping edge). They render the knife softer in torsion and have the effect of the knife being able to conformly bear on the surface of the grinding roller in sectors.

In the embodiments with the first recesses, incisions and/or subdivisions, the knife holder in particular is designed in a dimensionally stable (stiff) manner, for example by way of it being formed by one or more metallic bodies. In particular, the knife is supported by the knife holder in a direct manner without an elastic intermediate element or the like, so that the position in the region of the knife which is received by the knife holder is defined over the complete axial extension. The conforming contact behaviour is therefore defined by the blade itself.

Herewith, the initially outlined problem of the adaptation to the roller surface is solved in a simple manner. On account of the first recesses, incisions and/or subdivisions, the knife can bend in a relatively flexible manner, so that the scraping edge can follow for example a cambering of the roller quite well. However, the necessary stiffness is not compromised in directions along the knife plane, specifically in the y-direction, i.e. the scraping function of the knife is ensured independently of the first recesses. The disadvantages of knives which are too thin or ones which are too long (in the y-direction) are also avoided.

According to the concept of providing the knife with first recesses, incisions and/or subdivisions, the flexibility of the knife and finally its capability of adapting itself to the roller surface and transmitting a pressing force is defined by the stiffness of the knife. This has been found to be particularly advantageous. Firstly, due to the dimensions and shapes of the first recesses, incisions and/or subdivisions, the bending stiffness of the knife in the region below the scraping edge can be set in a practically arbitrary manner, if necessary also changing over the axial length of the knife, and specifically without adaptations of the knife holder becoming necessary. Secondly, no elastomeric materials or other plastic materials whose characteristics could change over the course of time need to be used.

In embodiments with first recesses, these are distributed for example in a regular arrangement along the axial extension of the knife, for example in a (single) row. Webs can be formed between the first recesses, the webs connecting an axially continuous scraping edge region to a likewise axially continuous middle region. The width of the webs at the narrowest location is selected according to the desired flexibility. It can be smaller than the width of the recesses, in particular by at least a factor of 2, at least a factor of 3 or at least a factor of 5.

In particular, the first recesses can be rectangular. This has the advantage that the webs run in the y-direction (y-directions here are directions along the knife surface towards the scraping edge or away from this), and between the recesses over their length can have a roughly constant width. By way of this, given a bending of the blade (for the adaption to the roller surface) the bending is uniform in the region of the webs. However, one also does not rule out the first recesses having other shapes, for example being elliptical or circular or hexagonal etc.

The concept of the knife with the first recesses between the scraping edge and the knife holder of the type which is discussed in the present text, with incisions and/or subdivisions, is particularly favourable in combination with the knife holder which (in particular without a counterweight) is pressed against the roller on account of the spring force, i.e. in scrapers and roller mills according to the first aspect. According to a further, second aspect of the invention, the concept however can also be used in roller mills without this pressing mechanism, i.e. very generally in roller mills with a pair of grinding rollers and with a knife with a scraping edge which can be pressed against a surface of one of the grinding rollers. The advantage of the uniform conformable contact on the surface of the roller results independently of the type of generation of the pressing force.

According to a third aspect of the present invention, it is a question of the following problem: knifes of scrapers of the type which are described here have a limited service life, since they become worn with time. This service life is often approx. one to three years depending on the intensity of use. Once the scraping knife is worn down, it no longer sufficiently frees the grinding roller from the sticking product. Rather, circumferential product strips form on the surface of the grinding roller. These result in the machine no longer grinding in a correct manner and the increase of vibrations. Generally, the operator only recognises on the basis of such insufficient results that the knife is now worn down and needs to be exchanged. It would therefore be desirable if a mechanism by way of which the operator is made aware of the fact that the knife will soon be worn down were to be present.

The third aspect can then be implemented on its own. It can also be combined in an advantageous manner with the first and/or the second aspect. Concerning this third aspect, it is likewise the case of a scraper for a roller mill with a pair of grinding rollers as well as such a roller mill with the pair of grinding rollers and the scraper whose knife is pressed against one of the grinding rollers (for example the two knives are pressed each against one of the grinding rollers). The scraper likewise includes a knife with a scraping edge which is pressable against a surface of one of the grinding rollers. In the course of time, the scraping edge relocates “downwards”, i.e. in the direction of the rear side, due to the wearing—and a little material of the knife is continuously worn away at the front side, on the scraping edge. According to the third aspect, the knife includes at least one cut-out—for example a plurality of marking recesses—which are arranged such that it bears on the scraping edge when the life duration of the knife has been reached. Herein, the marking recesses have a low width (extension in the x-direction, i.e. in the direction parallel to the scraping edge) of for example less than 5 mm, in particular 3 mm at the most, at least at their front end. By way of this, fine traces of grinding material which has not been scraped away arise on the roller as soon as the material at the front side of the marking recesses has been worn away. These traces are visible to the user and signalise the fact that the knife will soon have to be replaced. Despite this, the knife can still be used for a certain time without any problem and without increased vibrations being generated, for example until the point in time for replacement is favourable.

The marking recesses in particular can be tapering towards the front side, so that the arising traces are firstly very narrow and then become wider. The marking recess can have the shape for example of small triangles with a tip pointing towards the front side.

The following applies to all aspects of the invention.

The mounting of the knife in the knife holder in particular can be accomplished by way of a plurality of contact portions of the knife holder bearing on the knife and letting the knife holder act as a knife clamp. For example, a first, second and third contact portion can be present and be offset to one another, wherein the first and the third contact portion bear on one side of the knife and the second contact portion on the opposite, other side of the knife. Herein, the second contact portion is between the first and the third contact portion in the y-direction. Hence a clamping can be effected on account of the elasticity of the knife, so that the knife can be clamped and an additional fixation for example via screws or the like becomes superfluous.

However, one also does not rule out the knife being clamped between two blocks or the like, of the knife holder, wherein then additional means can be present, in order to press the blocks against one another and/or to fix the knife.

Regarding the solution with contact portions which are offset to one another, it is the case that: the contact portions extend in the axial direction of the complete extension (width) of the knife. They can form an uninterrupted contact line. However, it is also possible for one of the contact portions to be present in the region of the (first) recesses, i.e. for the contact portions to bear on the webs between the recesses.

As a further possibility, the knife (independently of whether first recesses, incisions, subdivisions and/or marking recesses are present or not) can form second recesses which can interrupt the contact lines which are defined by the first, second and/or third contact portion (or lie between these). The second recesses are arranged in the region (clamping region) which is received by the knife holder and thus increase the flexibility of this region, which is why the clamping effect which is mentioned above can be improved yet further by way of a somewhat larger bending of the knife in the clamping region being possible.

According to an embodiment, the second recesses can be arranged on the knife at the lower side, and optionally they can be open to the bottom, so that the knife forms lower-side, shouldered cams. The lowermost (first) contact portion can be present in the region of these lower-side cams. By way of this design, the knife becomes somewhat more flexible also in the region of the first contact portion.

In particular, the knife therefore, from the scraping edge, can firstly include an axially continuous scraping edge region, a region with the first recesses, an axially continuous middle region and a lower region with downwardly projecting cams.

By way of the design with the offset contact positions, the knife holder as a knife clamp in particular can be free of connection elements (screws or the like) in the product space. This is particular advantageous with regard to hygiene and also regarding the simple exchangeability of the knife.

Apart from the scraper, the invention also relates to a roller mill with a scraper.

### BRIEF DESCRIPTION OF THE DRAWINGS

Embodiment examples of the invention are hereinafter described by way of drawings. In the drawings, the same reference numerals denote equal or analogous elements. The drawings are partly schematic and are not true to scale. In part, these show elements which correspond to one another in different sizes from figure to figure. There are shown:

FIG. 1 schematically, a region of a roller mill with a scraper;

FIG. 2 a region of a scraper in a perspective view;

FIG. 3 a region of one of the knives;

FIG. 4 a sectioned representation of the knife clamp of the scraper of FIG. 2;

FIG. 5 the scraper of FIG. 2 with—shown dashed—elements present in the inside of the knife clamping;

FIG. 6 a view of the scraper of FIG. 2 from an end side;

FIG. 7 a region of an alternative knife;

FIG. 8 a region of a multi-part knife;

FIG. 9 a partial lateral view of an alternative scraper with a grinding roller of a disengaged pair of grinding rollers;

FIG. 10 a view analogous to FIG. 9, wherein the grinding rollers are engaged; and

FIG. 11 a region of a knife with marking recesses.

### DETAILED DESCRIPTION OF THE INVENTION

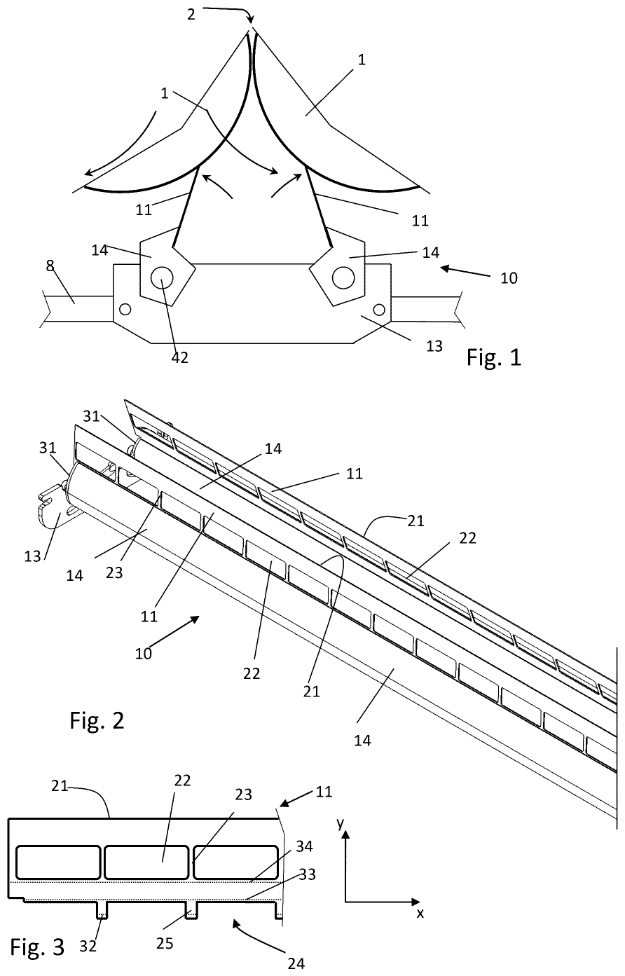

FIG. 1 shows a pair of grinding rollers, between which a grinding gap 2 is formed. A scraper 10 is designed as a unit with two scraping devices which are assembled on a base with a base plate 13 and which are each with a knife 11 and a knife holder in the form of a knife clamp 14. The knives 11 are pressed against the rotating grinding rollers in the direction of the arrows, in order to scrape away grinding material which sticks to the respective roller surface. Herein, as is known per se, the knife is arranged at an angle to the normal to the roller surface, i.e. at an angle to the radial plane through the contact line.

The base is fixedly assembled relative to the rotation axes of the grinding rollers. The chassis 8 of the grinding roller, on which chassis the base plate 13 is fastened is schematically indicated in FIG. 1. The “chassis” can include a framework and/or a supporting housing or other parts which are not movably assembled.

FIG. 2 shows a region of the scraper 10 in a perspective view. One recognises that the knives 11 below the scraping edge 21 include a row of recesses 22, between which narrow webs 23 are formed.

The base as already mentioned includes an end-side base plate 13; at the opposite side (not visible in FIG. 2) the base can include a further base plate or another structure which pivotably receives the knife clamps 14.

The two knife clamps 14 are each designed as profile which is extended along the axis. An end plate 31 which is connected to the knife clamp 14 in a rotationally fixed manner is present at each end side on the knife clamps 14.

In FIG. 3, one can see a region of one of the knives 11. The knife apart from the recesses 22 with the webs 23 which lie therebetween also includes lower-side, downwardly open second recesses 24, between which lower-side, shouldered cams 25 are present.

FIG. 3 also illustrates coordinates of a Cartesian coordinate system. In the present text, the axis which is parallel to the knife surface of the scraping edge 21 and to the axis of the grinding rollers is denoted as the x-axis and corresponding directions also as “axial” directions. Directions which are perpendicular to this along the knife surface “towards the roller surface” and “away from the roller surface” correspond to the y-direction or −y-direction; according to the arrangement which is represented in FIG. 1, they are also denoted as “upwards” and “downwards” respectively. The y-axes of the two knives are herein generally not parallel to one another, i.e. the coordinate system is to be understood in respect to the respective knife.

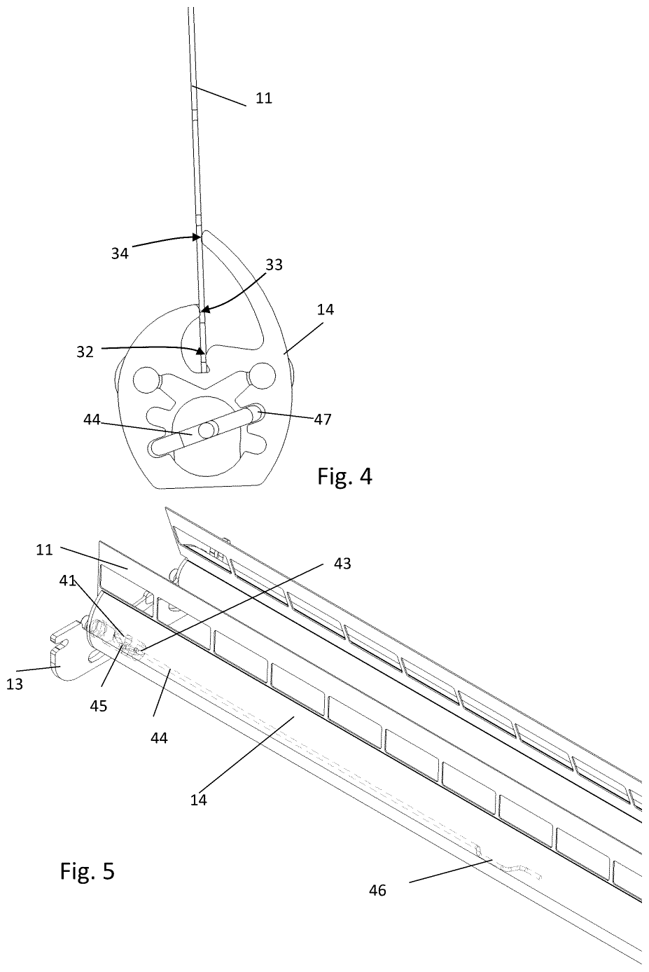

FIG. 4 shows a sectioned representation through one of the knife clamps 14 with a clamped knife 11. The knife is clamped by way of it bearing on three axially extending contact portions 32, 33, 34 which are offset to one another, and in this manner is clamped. The knife clamp 14 is manufactured of a for example relatively hard and shape-stable material, for example aluminium. The contact portions can act in a clamping manner by way of them effecting a minimal bending of the knife—which is more elastic due to its thickness and/or due to its material composition—which is why the knife resiliently clamps in the knife clamp 14. The preloading of the knife therefore ensures the retention of the knife in the knife clamp.

The lower-side second recesses 24 in this context serve for yet increasing somewhat the elasticity in the region of the first contact portion 32 by way of it first and foremost being the shouldered cams 25 which slightly bend on clamping. The regions on which the first, second and third contact portion bear 32, 33, 34 are indicated in FIG. 3 by dotted lines.

The necessary pressing force is effected by a spring. As is particularly evident in FIG. 5, the base includes a pin 41 which is attached to the base plate 13 in a rotationally fixed manner-which can also be of one piece with the base plate. The pin 41 in an exactly fitting manner projects into the inside of a cylindrical, axially running guide opening (42; schematically represented in FIG. 1) of the knife clamp 14 which is coaxial to the pivot axis of the knife clamp 14 and which defines this pivot axis.

A fixation slot 43 into which a cranked end 45 of a torsion spring 44 projects is present on the pin 41. A second crank 46 which is present in the proximity of the other end engages into a slot-like, radial projection 47 of the guide opening, by which means the—biased—torsion spring 44 presses the knife clamp 14 in the direction against the grinding roller 1, as is represented in FIG. 1 by an arrow. Other types of springs and corresponding mechanisms with which the knife clamp 14 is pressed in the envisaged rotation direction on account of the spring action of one or more spring(s) which are supported on the base are conceivable, for example a helical spring which at the one side engages on the fixation slot 43 of the pin and at the other side on the rail projection, or a tension spring or compression spring, which externally engages on the base and on an engagement point of the knife clamp.

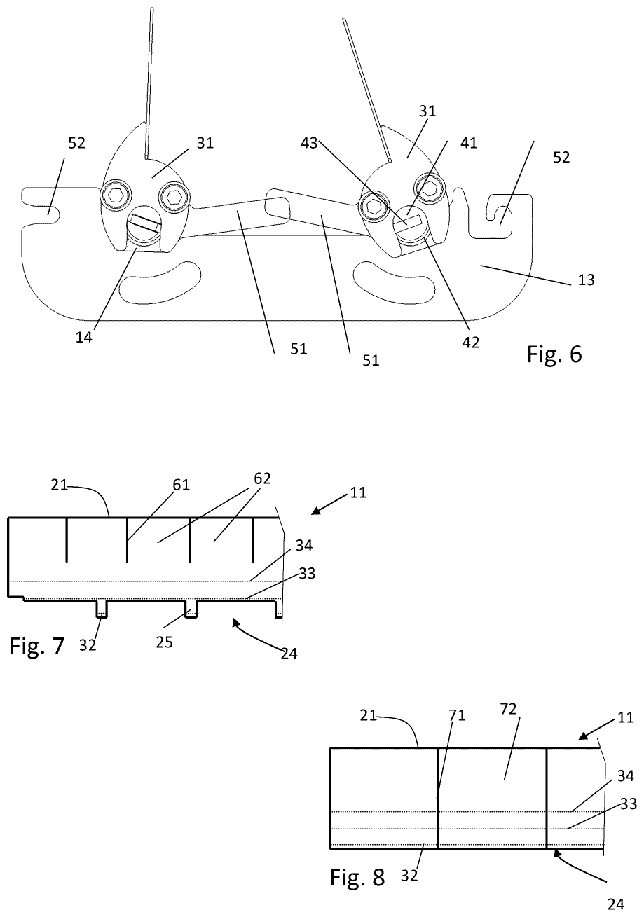

In FIG. 6 one can see a view of the scraper from the end side (with respect to the axial directions). The end plates 31—fastened to the respective knife clamp 14 by screws—each include a restoring arm 51. A mechanism for example can engage on this arm, the mechanism deflecting the knife clamps counter to the spring force, so that the knives no longer contact the grinding rollers as soon as the grinding rollers are disengaged, i.e. moved apart. This prevents the knives from then rubbing on the grinding rollers when these rotate without a product being ground between them.

The recesses 52 of the base plate 13 which are particularly well visible in FIG. 6 serve for the assembly of the scraper—preassembled as a unit—on the chassis of the roller mill.

FIG. 7 shows an alternative knife 11 without the recesses, but instead with incisions 61. This is interrupted in the y-direction up to the scraping edge 21, thus by the incisions 61. A row of tongues 62 arises by way of this, the tongues extending from an axially continuous region up to the scraping edge 61 and being able to individually conformably bear on the roller surface. The knife in the represented example, as that of FIG. 2-6, includes lower-side; downwardly open second recesses 24, between which lower-side shouldered cams 25 are present.

In FIG. 8, the incisions are replaced by way of subdivisions 71 which are continuous in the y-direction, by which means the knife is of several parts and is subdivided into a plurality of part-knives 72 which are arranged next to one another. The part-knives are arranged directly next to one another and can all have the same width (extension in the x-direction), or the width can be adapted in accordance with requirements, for example be smaller or larger in the edge region than in a middle region. Even in the case of embodiments with subdivisions, lower-side (second) recesses are an option, wherein then for example the number of the cams which are shouldered at the lower side can be the same for all part-knives, i.e. the positioning of the cams and the subdivisions can be matched to one another.

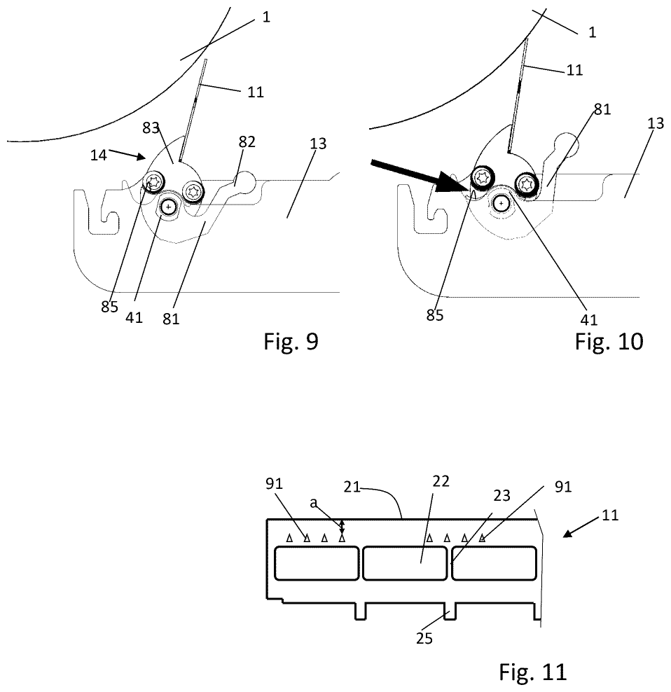

FIGS. 9 and 10 illustrate the principle of designing the base in a multi-part manner in order to provide a moving base part for the knife holder of at least one of the knives, wherein the knife holder is tensioned relative to the moving base part by way of the spring and the movable base part is pivoted given the engagement and disengagement movement.

The disengaged state is represented in FIG. 9. Apart from the base plate 13, the base also includes a moving base part in the form of a base pivot unit, specifically a pivot plate 81. Given the engagement and disengagement movement, this pivot plate is pivoted by the disengagement mechanism of the roller pair, for example by way of a lug of the disengagement mechanism (not shown) interacting with a pivot plate arm 82. The pin 41 which analogously to the aforedescribed embodiment interacts with an end of the torsion spring is mounted relative to the pivot plate 81 and participates in its pivoting movements.

The pivot plate 81 moreover in the represented example forms a stop 85, on which, in the disengaged state (FIG. 9) an element of the knife holder—in the represented example a stop plate 83 which is fixedly screwed to the knife clamp—abuts on account of the spring force of the torsion spring, by which means the knife 11 is situated in a defined position, in which the scraping edge does not abut on the grinding roller 1.

If the pivot plate 81 is pivoted into the engaged state by the disengagement mechanism (FIG. 10), then on the one hand the stop 85 is moved such that a pivoting of the knife with the knife clamp 14 towards the grinding roller is no longer prevented (see arrow in FIG. 10). On the other hand, by way of the pivoting of the pin 41, the end of the torsion spring which is connected thereto is also co-pivoted, which additionally tensions the torsion spring and has the effect of this pressing the knife against the surface of the grinding roller 1 (to a greater extent).

In variants, it would also be possible to make do without the stop 85 or alternatively to forgo the provision of the pin 41 on the moving base part. In the latter case, the torsion spring however on disengaging would be tensioned to a greater extent, so that a part of the disengagement movement would be effected counter to the spring force of the torsion spring—which is prevented by the embodiment of FIGS. 9 and 10. If the disengagement movement—as is described for example in the patent application CH 000 148/2023—is effected by a spring, then such a spring must be particularly strong if it is to act counter to the spring force of the torsion spring and to always ensure a defined state—which in turn results in more energy having to be applied for the engaging movement. The solution according to FIGS. 9 and 10 which prevents this, contributes to the reliability as well as the energy efficiency.

FIG. 11 illustrates a knife 11 with window-like recesses 22 of the aforedescribed type and additionally with marking recesses 91. The marking recesses 91 are arranged at a distance a to the scraping edge 21. This distance a is selected such that the knife 11 still fulfils its function when all material between the (initial) cutting edge 21 and the marking recesses 91 has been ground away, i.e. when the cutting edge 21 has displaced to the marking recesses 91 due to wearing. A material removal up to the rear side (lower side in FIG. 11) of the marking recesses 91 or even beyond this however would no longer be tolerable. As soon as the position of the cutting edge is displaced towards the marking recesses 91, fine marking strips arise on the surface of the grinding roller due to the marking recesses. These strips indicate to the operator that an exchange of the knife is soon required.

On account of the optional, triangular shape of the marking recesses 91 which tapers towards the front side, the marking strips become wider and wider if the knife 11 continues to be used—the marking becomes more noticeable with the increasing urgency.

1. A scraper for a roller mill which comprises a chassis which carries a pair of grinding rollers between which a grinding material can be reduced in size, wherein the scraper comprises a knife with a scraping edge which can be pressed against a surface of one of the grinding rollers, as well as a knife holder to which the knife is fastened, characterised by a base which can be assembled on the chassis, wherein the knife holder can be biased against the surface of the grinding roller relative to the base by way of a spring force and thus can be pressed by this against the grinding roller.

2. The scraper according to claim 1, which for each of the two grinding rollers of the pair of grinding rollers comprises a scraping unit with a knife and with a knife holder which can be biased against the surface of the grinding roller relative to the base by way of a spring force and thus can be pressed by this against the grinding roller.

3. The scraper according to claim 2, wherein the knife holders of the two scraper units are both assembled on the base as a common base, by which means the scrapers can be fastened as an assembly to the chassis.

4. The scraper according to claim 1, comprising at least one spring for applying the spring force.

5. The scraper according to claim 4, wherein the spring is present in a hollowing of the basis and/or of the knife holder.

6. The scraper according to claim 4, wherein the spring acts between a moving base part of the base on the one hand and the knife holder on the other hand, and wherein the moving base part of the base can be moved between an engaged and disengaged state by way of movements of the one grinding roller of the pair relative to the other grinding roller, in order to bias the spring in the engaged state.

7. The scraper according to claim 4, wherein the spring is a torsion spring.

8. The scraper according to claim 1, wherein the knife or at least one of the knives comprises a plurality of first recesses, wherein the first recesses are present between the knife holder and the scraping edge.

9. The scraper according to claim 1, wherein the knife or at least one of the knives comprises a plurality of incisions and/or subdivision, which extend up to the scraping edge.

10. The scraper according to claim 1, wherein the knife holder is a knife clamp in which the knife is clamped amid deformation.

11. The scraper according to claim 10, wherein the knife clamp comprises three contact portions which are offset to one another and of which one is arranged lying opposite the two other contact portions.

12. The scraper according to claim 10, wherein the knife comprises a plurality of second recesses which are arranged in a region which is received by the knife clamp.

13. The scraper according to claim 1, wherein the knife comprises at least one marking recess which is arranged at a distance to the scraping edge and which at least at its front end has an extension in the direction parallel to the scraping edge of 5 mm at the most.

14. A roller mill comprising a chassis which carries a pair of grinding rollers between which a grinding material can be reduced in size, as well as a scraper according to claim 1, wherein the base is fastened to the chassis and the scraper is arranged such that the scraping edge of the knife is pressed against one of the grinding rollers by way of the spring force.

15. The scraper according to claim 1 for a roller mill with a pair of grinding rollers, between which a grinding material can be reduced in size, wherein the scraper comprises a knife with a scraping edge which can be pressed against a surface of one of the grinding rollers, as well as a knife holder to which the knife is fastened, wherein the knife comprises a plurality of window-like first recesses and/or incisions and/or subdivisions.

16. The scraper according to claim 15, wherein the first recesses are present between the knife holder and the scraping edge and the scraping edge runs in an uninterrupted manner along its axial extension.

17. The scraper according to claim 15, wherein the incisions or subdivisions extend up to the scraping edge.

18. The scraper according to claim 15, wherein the first recesses are arranged in a row which extends in an axial direction.

19. The scraper according to claim 15, wherein the first recesses are rectangular.

20. The scraper according to claim 15, wherein a width of webs between the first recesses is smaller than a width of the first recesses by at least a factor of 2.

21. A roller mill comprising a pair of grinding rollers between which a grinding material can be reduced in size, as well as a scraper according to claim 15, wherein the scraper is attached such that the scraping edge of the knife is pressed against one of the grinding rollers.
